(19) United States
(12) Patent Application Publication
(10) Pub. No.: US 2017/0046980 A1
(43) Pub. Date: Feb. 16, 2017

(54) NUTRITION SYSTEM

(71) Applicant: INRFOOD, INC., Trophy Club, TX (US)

(72) Inventors: Keval Mehta, Trophy Club, TX (US); Donald P. O'Brien, Trophy Club, TX (US)

(21) Appl. No.: 14/823,289

(22) Filed: Aug. 11, 2015

(51) Int. Cl. G09B 19/00; A23L 1/29

(52) U.S. Cl. CPC G09B 19/0092; A23L 1/293; A23V 2002/00

(57) ABSTRACT

Various aspects of the disclosure include a nutrition system including: at least one computing device configured to perform the following: normalizing a list of dietary ingredients from a product ingredient listing attributable to a food item; sorting the normalized list of dietary ingredients, the sorting including assigning a weight to each of the normalized dietary ingredients according to a physical weight of the normalized dietary ingredient in the list of dietary ingredients; and providing the sorted normalized list in a visually discernable format.

### FIELD

The subject matter disclosed herein relates to nutrition. More specifically, the subject matter disclosed herein relates to nutrition systems and related methods.

### BACKGROUND

Nutrition is an increasingly pertinent concern for people across the world. As the development of new and more convenient food products has increased, so has the complexity of the composition of those food products. Unfortunately, consumers are often under-informed or misinformed about the composition of the food products that they ingest.

### BRIEF SUMMARY

Various aspects of the disclosure include a nutrition system and related methods. In some embodiments, a nutrition system includes: at least one computing device configured to perform the following: normalizing a list of dietary ingredients from a product ingredient listing attributable to a food item; sorting the normalized list of dietary ingredients, the sorting including assigning a weight to each of the normalized dietary ingredients according to a physical weight of the normalized dietary ingredient in the list of dietary ingredients; and providing the sorted normalized list in a visually discernable format.

A first aspect of the disclosure includes a nutrition system having: at least one computing device configured to perform the following: normalizing a list of dietary ingredients from a product ingredient listing attributable to a food item; sorting the normalized list of dietary ingredients, the sorting including assigning a weight to each of the normalized dietary ingredients according to a physical weight of the normalized dietary ingredient in the list of dietary ingredients; and providing the sorted normalized list in a visually discernable format.

A second aspect of the disclosure includes a system including: at least one computing device having: a processor; and a memory, the memory including a database having a set of product ingredient listings attributable to a set of food items, the at least one computing device configured to provide nutrition information about a food item in the set of food items by performing processes including: normalizing a list of dietary ingredients from a product ingredient listing attributable to the food item, the product ingredient listing stored in the set of product ingredient listings in the database; sorting the normalized list of dietary ingredients, the sorting including assigning a weight to each of the normalized dietary ingredients according to a physical weight of the normalized dietary ingredient in the list of dietary ingredients; sorting the normalized dietary ingredients into three groups, wherein all of the normalized dietary ingredients are assigned a point value, the point value based upon membership in one of the three groups; and providing the sorted normalized dietary ingredients in a visually discernable format.

A third aspect of the disclosure includes a computer program stored on a computer-readable storage medium, which when executed by at least one computing device, causes the at least one computing device to perform a process of providing nutrition information about a food item, the process including: normalizing a list of dietary ingredients from a product ingredient listing attributable to the food item; sorting the normalized list of dietary ingredients, the sorting including assigning a weight to each of the normalized dietary ingredients according to a physical weight of the normalized dietary ingredient in the list of dietary ingredients; and providing the sorted normalized list in a visually discernable format.

### BRIEF DESCRIPTION OF THE DRAWINGS

FIG. 1 illustrates a flow chart depicting a method according to various embodiments of the disclosure.

FIG. 2 shows an example product listing for a food product.

FIG. 3 shows an example of a normalized ingredient list according to various embodiments of the disclosure.

FIG. 4 shows an example chart depicting the normalized list of FIG. 3, sorted by a health criteria weight.

FIG. 5 shows a stacked chart included a sorted grouping of dietary ingredients according to various embodiments of the disclosure.

FIG. 6 shows a summary display indicating nutrition points according to various embodiments of the disclosure.

FIG. 7 shows an example bar graph depicting a comparison in nutrition points between two food items, according to various embodiments of the disclosure.

FIG. 8 shows the example bar graph of FIG. 7, with particular indication of ingredients based upon corresponding health values.

FIG. 9 shows an example summary chart for a food item, presented according to various embodiments of the disclosure.

FIG. 10 shows an environment according to various embodiments of the disclosure.

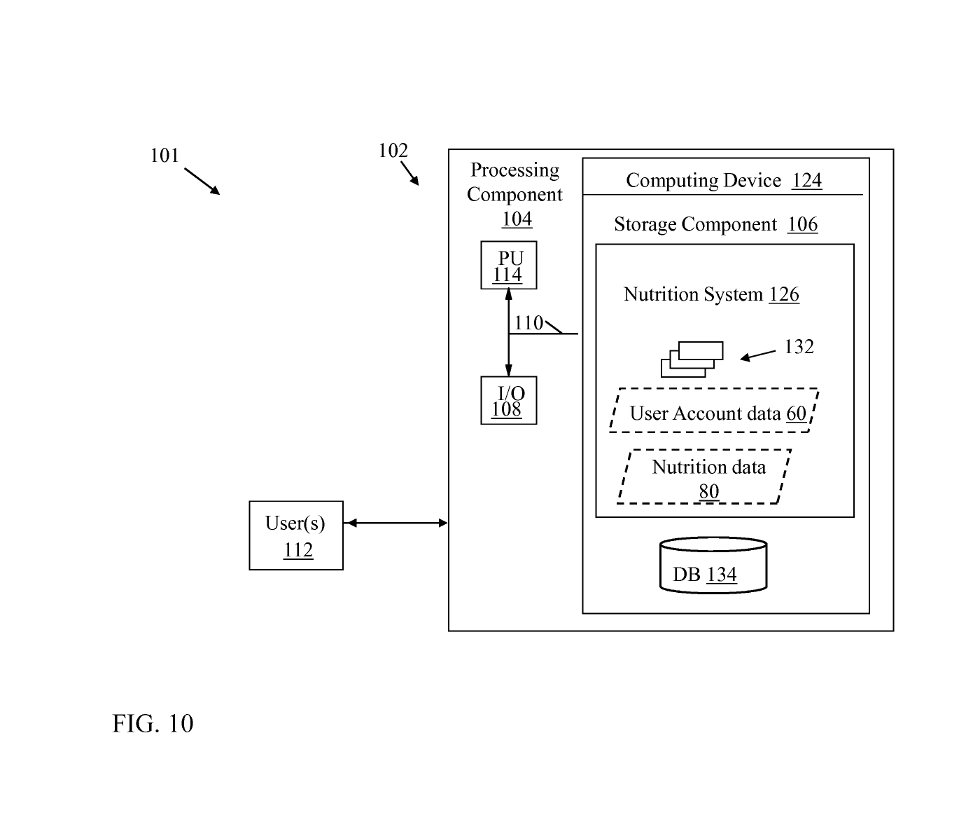

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION

As noted herein, the subject matter disclosed herein relates to nutrition. More specifically, the subject matter disclosed herein relates to nutrition systems and related methods

In the following description, reference is made to the accompanying drawings that form a part thereof, and in which is shown by way of illustration specific example embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely illustrative.

Various embodiments include a nutrition system including at least one computing device configured to perform the following: normalizing a list of dietary ingredients from a product ingredient listing attributable to a food item; sorting the normalized list of dietary ingredients, the sorting including assigning a weight to each of the normalized dietary ingredients according to a physical weight of the normalized dietary ingredient in the list of dietary ingredients; and providing the sorted normalized list in a visually discernable format.

In some embodiments, the nutrition system includes a database that stores information about food items, and further, information about particular dietary ingredients in those food items. This information can include, for example, caloric content, chemical composition, etc. In various embodiments, the database stores information including the full nutrition facts panel (NFP) and ingredients information for a plurality of products. The database also stores information about dietary preferences, concerns and types (e.g., vegan, non-gmo (genetically modified organism), gluten free, vegetarian, low sodium, organic etc.). The database can also include a master list and subcategory list for each product (e.g., Meat (master) Beef & Veal (sub)), and also maintain up-to-date UPC (Universal Product Code) listings, package and material types (e.g., glass bottle, HDPE (high-density polyethylene) container, etc.). For each stored ingredient, the database maintains up-to-date listings of the name, Advisory color (red, yellow, green), category of ingredient up to 2 (i.e. humectant, solvent, preservative etc.), negative and positive key points of ingredient, nutrients high in, sign/symptom of ingredient (with respect to health), detailed research on that ingredient (e.g., function, health effects, origin, other uses, etc.), Ph of the ingredient (if available), and health concern flags (e.g., causes for health concern such as possible carcinogens, mercury concentration, product recall concerns, glycemic index of ingredients, etc.).

In some cases, the information about the food items can be displayed in a color-coded or otherwise visually discernable manner in order to easily distinguish between types of items, ingredients, nutritional values, etc. In some cases, the nutrition system can obtain a standard food label (in any form), including ingredient information, and transform that label into a vertical list of ingredients that is color-coded, and standardized (e.g., for deviations/variations of naming) to a single format.

In many cases, the nutrition system is configured to obtain a nutrition label (or information used to construct a nutrition label (e.g., the “Nutrition Facts” label commonly seen on food items), normalize the ingredients listed on that nutrition label, and provide information about the composition and sub-composition of those ingredients. The nutrition system can compare those ingredients, or the entirety of the label, with other food items (using their corresponding nutrition label data, or stored data in the database) in a normalized manner (e.g., accounting for differences in serving size, proportion of particular ingredients, and/or differences in categorizing of ingredients (such as distinct labeling, acronyms, embedded listing of ingredients, etc.)). The nutrition system can provide this comparison, e.g., to a user, in order to help the user make more informed decisions about nutrition. Further, the nutrition system can provide this comparison, in some cases, in graphical, color-based, multi-dimensional or other formats in order to ease the user's perception of differences in the food products. Additionally, the nutrition system can display any health concerns known to be connected with the ingredients (e.g., peanut allergies being a concern for peanut and peanut-derivative ingredients), as well as base its comparison between products in part upon those health concerns. For example, where high cholesterol is a concern for a user (e.g., as indicated in a user profile), the nutrition system may assign a lower health score to one product in a product comparison where that product has an ingredient with a significantly (not nominal) greater amount of cholesterol relative to the ingredients in the other product(s) in the comparison.

The nutrition system can also allow one or more users to establish a profile that can be stored and utilized to tailor analysis of food products according to the profile. For example, where a user has a dietary concern such as a gluten allergy, the user can store this information in the profile, and when providing ingredient information, the nutrition system can tailor this presentation to notify the user that products contain gluten or exclude gluten-containing products from search results. Further, the nutrition system can use the profile to tailor results for particular dietary concerns (e.g., carbohydrate intake, sugar content, fat concentration, etc.) and/or medical conditions (e.g., diabetes). It is understood that according to various embodiments, the user “profile” can be selected from a prepared list (or “playlist”) of dietary concerns. That is, the nutrition system can present the user with a predefined list of potential (e.g., popular) dietary concerns (e.g., concern for peanut consumption, such as for an allergy), from which the user can select. The nutrition system can then identify (flag) any and all peanut and peanut-derivative ingredients and the foods containing such ingredients in a subsequent search by the user. In various embodiments, the user can create his/her own custom prepared list (playlist), naming concerns for ingredients that he/she wants excluded from search results (for any reason).

It is understood that in various particular embodiments, the nutrition system can take the form of a mobile application (e.g., a mobile phone, tablet, or other portable electronic device-based application), web-based application, or any other conventional application. This mobile application can utilize existing portable electronic device-based hardware components to enhance the user experience, e.g., using the camera or bar-code reader to capture identifying information about a food product, using location-based information (e.g., from a GPS, Wi-Fi location based service, or other triangulation method(s)) to identify the proximity of particular food products, etc.

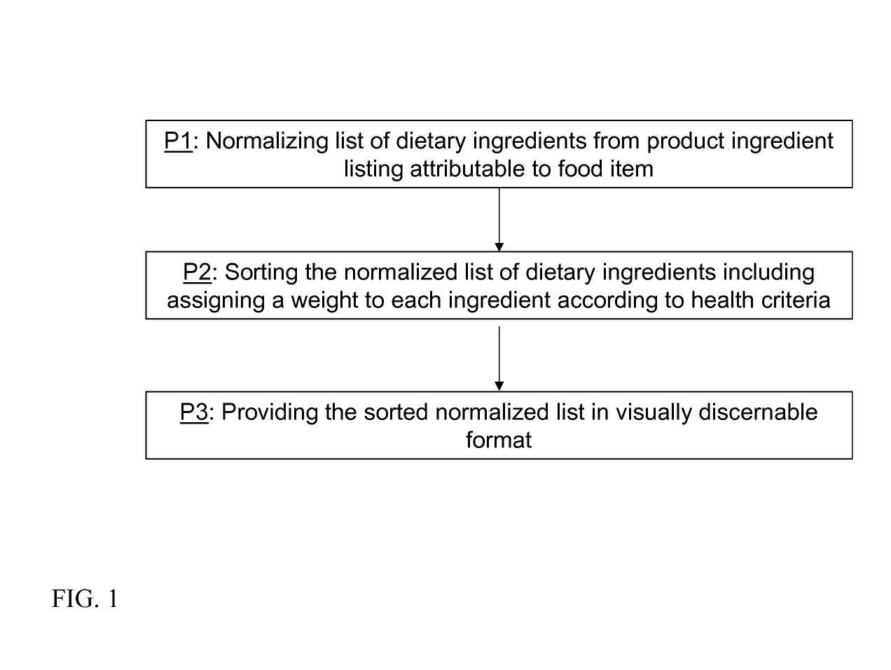

FIG. 1 shows a flow chart illustrating a method according to various embodiments. It is understood that the method(s) described herein can be performed by the described computer-implemented nutrition system, and/or by other computing devices (e.g., one or more distributed computing systems). The order of processes shown and described herein is merely illustrative, and as such, could be re-ordered according to various embodiments. In some cases, a method can include the following processes:

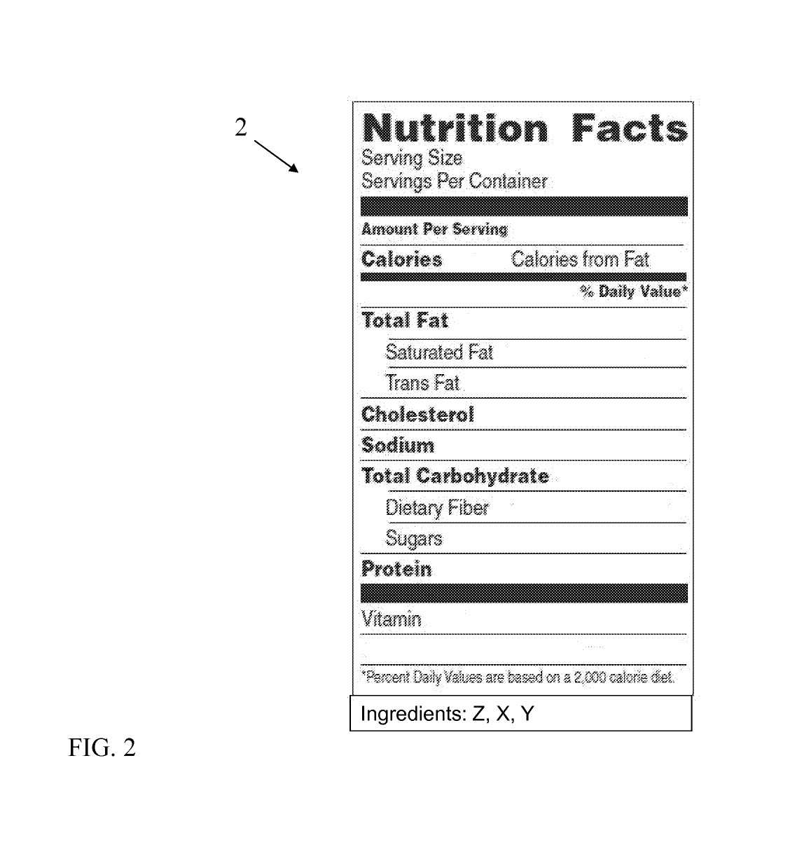

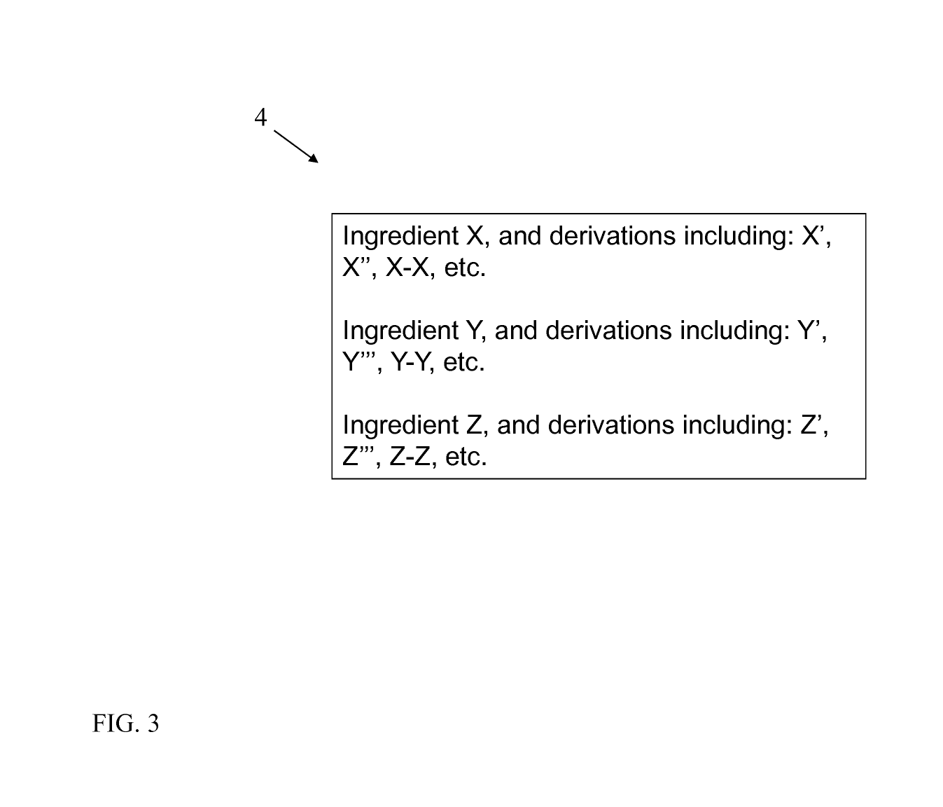

Process P1: normalizing a list of dietary ingredients from a product ingredient listing attributable to a food item. In various embodiments, this can include obtaining a list of dietary ingredients from a product ingredient listing attributable to a food item. FIG. 2 shows an example product listing 2 for a product, e.g., a food product such as a cereal (with percentages and ingredients omitted). It is understood that the product listing 2 shown is merely an example product listing, and that various product listings are compatible with the embodiments disclosed herein. The dietary ingredients can be listed under “Ingredients,” and can include, e.g., wheat, flour, enriched [ingredient], honey, corn syrup, sugar, etc. In some cases, dietary ingredients are listed in a non-uniform manner, for example, dehydrated mozzarella cheese [cheese [milk culture, rennet, salt]], nondairy creamer (partially hydrogenated vegetable oil (may contain soybean, sunflower, palm and/or canola)), United States Certified Colors (FD&C Blue #1, Blue #2, Red #40, Yellow #6 and Yellow #5, Lakes and Red #3). According to various embodiments, the nutrition system (and corresponding database) is populated with various names and derivations of names attributable to particular dietary ingredients. That is, according to various embodiments, the nutrition system can read a particular dietary ingredient (dietary ingredient X), and translate that dietary ingredient into a variety of derivations (dietary ingredients X′, X″, etc.) which may be present in other food items or as sub-components in other dietary ingredients. For example, the nutrition system described herein is adapted to detect ingredient listings (e.g., in product listing 2) with parenthesis, brackets, and/or acronyms. The parenthesis and brackets explain the composition of ingredients in a main ingredient. For example: butter (cream, salt); the cream and salt are ingredients making up the butter. In the case of oils, an example is: partially hydrogenated vegetable oil (canola, corn); this listing identifies that both of the ingredients in the parenthesis are partially hydrogenated. In the case of acronyms: Red 40 (Allura Red) can be written R40, #40, Red40, Red #40, #40 Color, Allura, Red Color Dye 40, as well as in many other manners. The nutrition system shown and described according to various embodiments is adapted to read (e.g., via text recognition, optical character recognition, or other conventional data sorting (e.g., when listing 2 is read as a data file) any one of the derivations in the dietary ingredient and identify the generic (or alternative) name for that ingredient. In the case of Red 40 (Allura Red), the nutrition system can relate any or all of the example derivations listed herein to the common ingredient name (Red 40 (Allura Red). An example of a normalized ingredient list 4 is shown in FIG. 3.

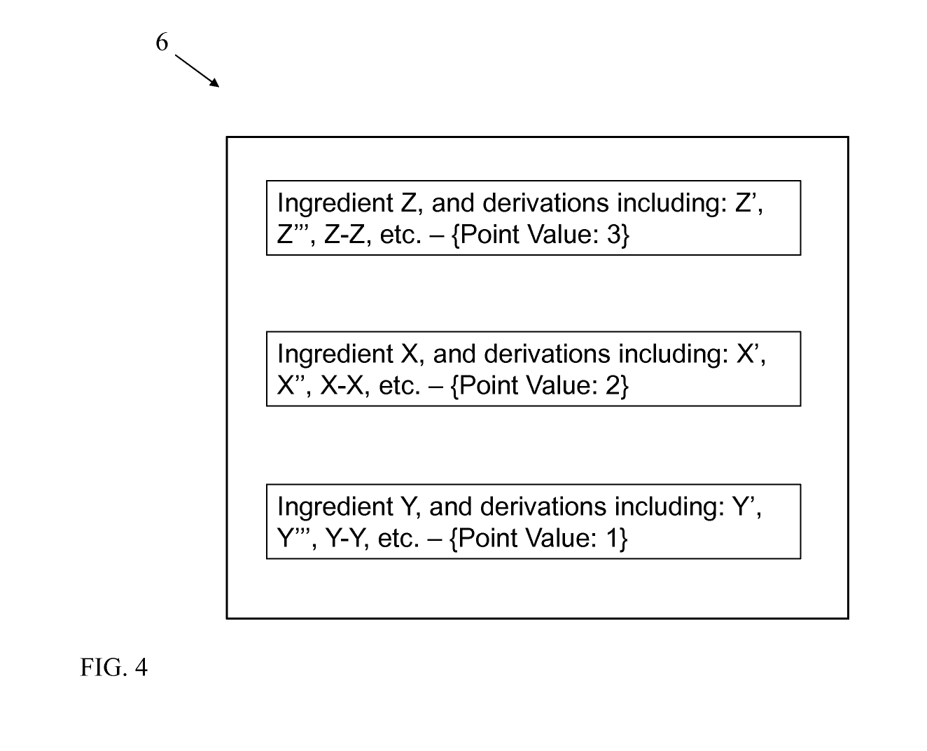

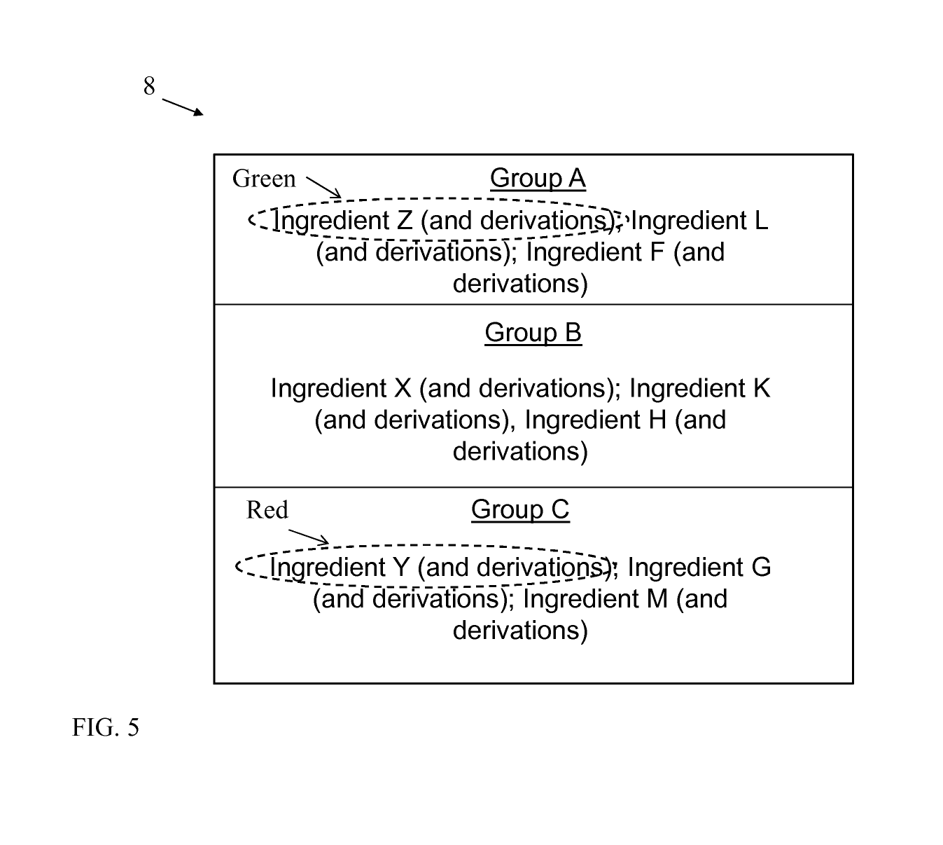

Process P2: sorting the normalized list of dietary ingredients 4, the sorting including assigning a weight to each of the normalized dietary ingredients according to a physical weight of the normalized dietary ingredient in the list of dietary ingredients 4. For example, as shown in the chart 6 on FIG. 4, the normalized list 4 of FIG. 3 is sorted by the associated physical weight in product listing 2 (where ingredient Z is listed first; ingredient X second; and ingredient Y third). It is understood that according to various embodiments, the normalized list can be sorted vertically, in order to allow the nutrition system to more easily group ingredients as described herein. In some cases, such as in the example chart 6, the normalized dietary ingredients are assigned a point value, for example, one, two or three points (although any number of point values may be assigned). The point value (weight) can be assigned according to the physical weight of the ingredient in the food product (ingredient listing). That is, conventional ingredient listings display ingredients in descending order of physical weight in the overall food product, where the first ingredient has the greatest physical weight in the food product. The nutrition system sorts the ingredients in the ingredient listing 4 into groups (e.g., three groups), dividing those ingredients based upon their physical weight in the product. For example, where an ingredient listing consists of six (6) ingredients, and three groups are used: ingredients #1 and #2 are sorted to group A (3 points); ingredients #3 and #4 are sorted to group B (2 points); and ingredients #5 and #6 are sorted to group 3 (1 point). In various embodiments, as shown in FIG. 5, the nutrition system can also color-code particular ingredients based upon their associated health concerns. For example, where an ingredient is associated with a dietary concern (e.g., gluten, for gluten allergy concern; peanuts, for peanut allergy concern; high-cholesterol, for blood-pressure concern), that ingredient can be color-coded in the listing provided by the nutrition system. Ingredients can also be color-coded based upon a known healthfulness score. For example, in FIG. 5, Ingredient Z can be color-coded as green (healthy) where it matches an ingredient indicated as healthy in the nutrition system database (e.g., kale, broccoli, etc.). Ingredient Y may be color-coded as red (unhealthy) where it matches an ingredient indicated as unhealthy in the nutrition system database (e.g., high fructose corn syrup). The healthfulness of a product (“healthy” v. “unhealthy” can be determined based upon data gathered and stored in database from health professionals. For example, nutrition system can include a script that searches for keywords in medical journals, medical articles, news articles, research papers, etc. (internationally) and other data sources for ingredients to gather a consensus view about one or more particular ingredients. In various embodiments, where an ingredient is listed as including component ingredients (e.g., Product K, having: Salt, Water and Vegetable Oil (Canola, Corn, Peanut)), the nutrition system does not consider the sub-components as separate ingredients, but rather, as components making up their upper-level ingredient. For example, Product K includes: Salt, Water and Vegetable Oil (Canola, Corn, Peanut), where Salt is assigned a point value of (3), water is assigned a point value of (2), and each type of Vegetable Oil (Canola, Corn, and Peanut) is assigned a point value of (1). As such, Product K has a total point value of 8 points (3 points Salt, 2 points Water, 1 point Canola Oil, 1 point Corn Oil and 1 point Peanut Oil).

According to various embodiments, Process P3, which can follow Process P2, includes: providing the sorted normalized list in a visually discernable format. For example, the sorted grouping demonstrated in the stacked chart 8 in FIG. 5 demonstrates a variety of dietary ingredients sorted by their corresponding point values, where three example groups (Group A; Group B; and Group C) are shown in a visually discernable format (e.g., a chart).

An additional process, which can be performed as a corollary to Process P2 (and displayed as part of process P3) is to sort the normalized dietary ingredients into three groups (e.g., Group A; Group B; and Group C, in FIG. 4), where all of the normalized dietary ingredients are assigned a point value based upon membership in one of the three groups. In these embodiments, each of the normalized dietary ingredients is sorted according to a predetermined number of groups (e.g., three), and once assigned to a particular group, the normalized dietary ingredient is given a point value attributed to that group. As shown in the example scenario depicted in the charts of FIG. 4 and FIG. 5, in some cases, each of the normalized dietary ingredients in a first group (e.g., Group A) of the three groups is assigned a point value equal to three points, each of the normalized dietary ingredients in a second group (e.g., Group B) of the three groups is assigned a point value equal to two points, and each of the normalized dietary ingredients in a third group (e.g., Group C) of the three groups is assigned a point value equal to one point.

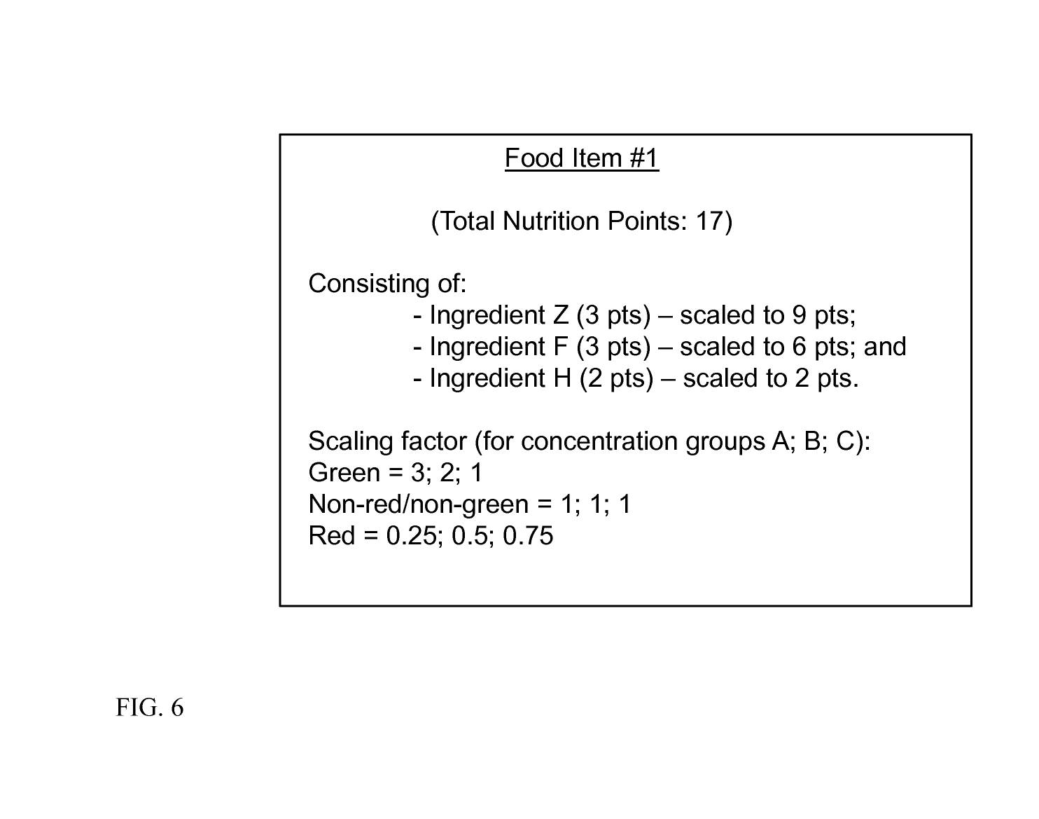

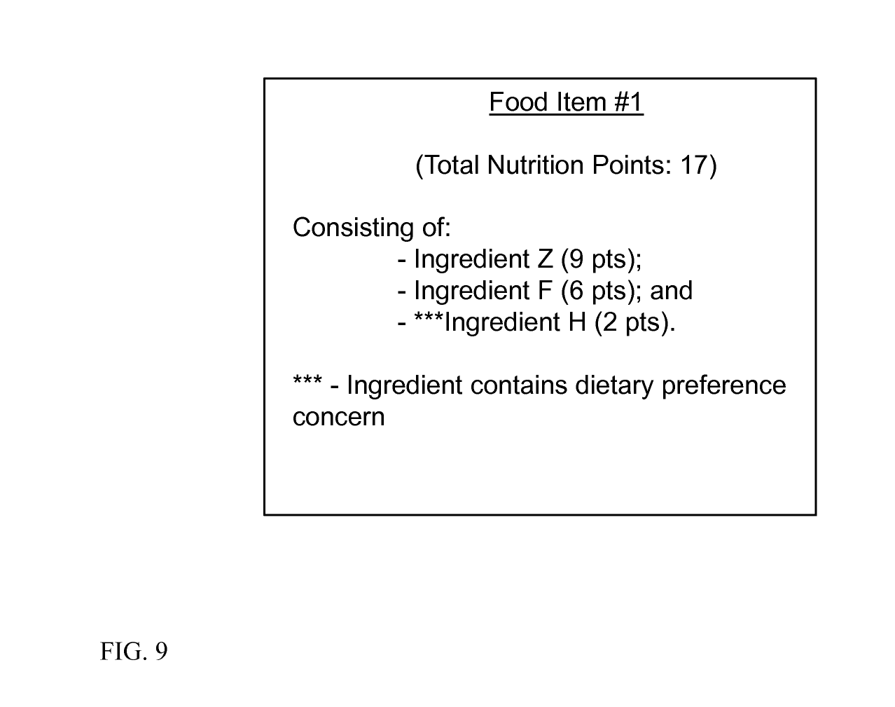

In various embodiments, the nutrition system is further configured to add all of the point values for the normalized dietary ingredients to provide an overall dietary score for the food item. FIG. 6 shows a summary display provided by nutrition system, indicating that Food Item # 1 has eight (17) total nutrition points, equal to a total number of nutrition points from its three (3) ingredients. The nutrition system can perform a scoring process according to the following steps: (a) evaluate the product to determine whether an absolute dietary concern exists (e.g., peanuts are present in an ingredient where a user has a peanut allergy, or meat is present where a user has a vegetarian preference). If the product has an absolute dietary concern, it may be flagged and not scored. If the product has a dietary concern that is not absolute, it may simply be flagged (e.g., as shown in FIG. 9). In various embodiments, tagging can include applying a label on a display indicating the concern, e.g., “peanut concern” where peanut oil is present or “shellfish concern” where the product includes any form of shellfish (e.g., lobster). Various ingredients can have multiple tags (displayed to the user), e.g., Red 40 (Allura Red), which is flagged for “pregnancy concern,” “artificial ingredient concern,” “artificial color concern,” and “excitotoxin concern.” These concerns can be displayed to the user, e.g., in a bold, color-coded or otherwise significant way where the corresponding ingredient is present in any location on the product label (regardless of mass).

After evaluating for dietary concern, the next step (b) includes evaluating the physical weight values of the ingredients in terms of their healthfulness. This includes weighting healthfulness scores (e.g., green as healthy, red as unhealthy) in terms of the physical weight of an ingredient in a product. Where a product has a higher physical weight of green ingredients (e.g., in Group A, FIG. 5), that product is assigned a higher scaled score. Where a product contains any red (unhealthy) ingredients, that product is assigned a lower scaled score. For example, as shown in FIG. 6, a scale may be applied to each of the ingredients in an ingredient list based upon its determined healthfulness, and its physical weight. In this case, a descending scaling factor is applied for the healthy (green) ingredients, while an ascending (between zero and 1) scaling factor is applied for unhealthy (red) ingredients. That is, a green ingredient with a high physical weight (weight score of 3), has a scaling factor of 3, which produces a 9 point ingredient. A non-red, non-green ingredient with any physical weight has a scaling factor of 1, which produces a 2 point ingredient. A red (unhealthy) ingredient with a low physical weight has a scaling factor of 0.75, which produces a 0.75 point ingredient. These scores can be used to adjust the point values already determined based upon physical weight, and provide an ultimate nutrition point score for a food item.

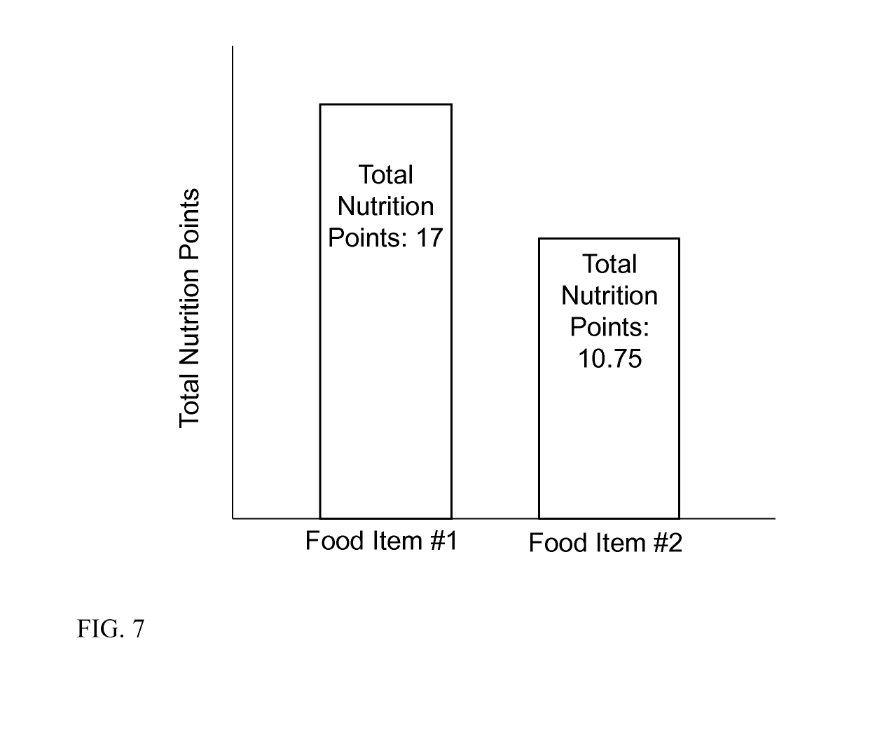

According to various embodiments, the nutrition system can repeat processes P1-P3 for any number of food items (e.g., using product ingredient listings). For example, the nutrition system can normalize a list of dietary ingredients from a second product ingredient listing 2 attributable to a second, distinct food item; sort the normalized list of dietary ingredients from the second product (item) including assigning a weight to each of the normalized dietary ingredients according to the physical weight of the normalized dietary ingredient in the list of dietary ingredients; (optionally: sort the normalized dietary ingredients from the second product into three groups, each group assigned a point value based upon membership in one of the groups); and provide a visual comparison of the point value of the second product (with distinct listing 2) with the point value of the product. This visual comparison is presented in FIG. 7, as an example bar graph, however, it is understood that this comparison could be presented in any graphical, pictorial, or other manner known in the art. The example bar graph in FIG. 7 depicts the comparison between the total point value (nutrition points) for Food Item # 1 versus Food Item # 2. It is understood that according to various embodiments, the nutrition system is configured to normalize between the second product (Food Item #2) and the first product (Food Item #1) for any difference in serving size or composition. That is, in assigning a total point value for each food item, the nutrition system can account for differences in serving size or composition of ingredients between multiple food products. As described herein, Food Item #1 in the examples has a nutrition point score of 17.

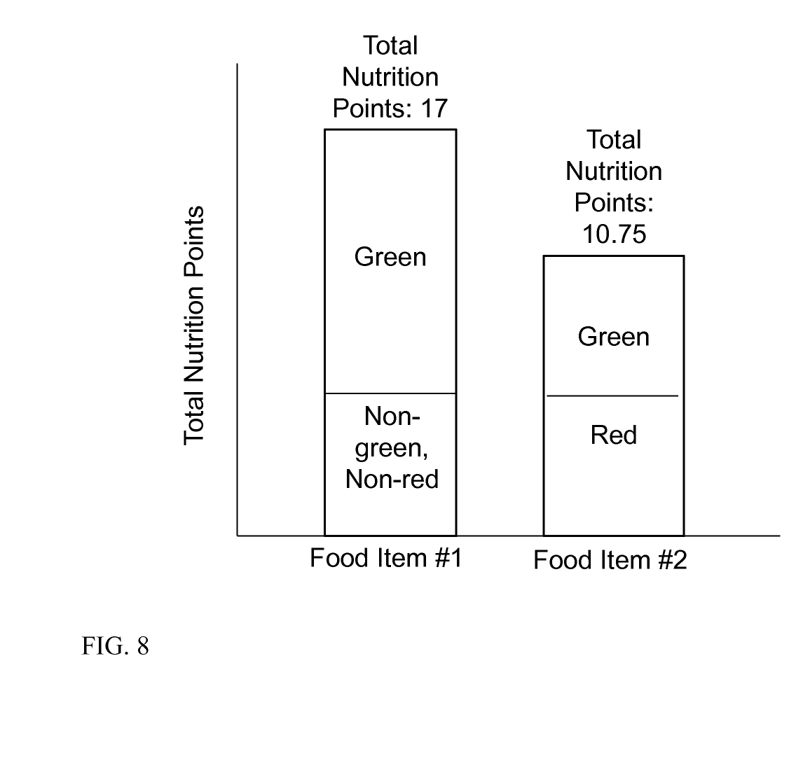

In some embodiments, the visual comparison can include color-coded listings of the normalized dietary ingredients for the first product (Food item #1) and the second product (Food item #2). This updated chart is shown in FIG. 8 as a bar graph, but it is understood that this could also be displayed as a pie chart or other chart as well. The color-coded listing shown in FIG. 8 illustrates a distinction (in both color and size) between Food Item #1 and Food Item #2, where Food Item #1 has 2 parts: one part green (one 3-point physical weight (scaled to 9 points); one two-part physical weight (scaled to 6 points)) and one part non-red/non-green, or neutral (one 2-point physical weight, scaled to 2 points). Food Item #2 has two parts: one part green (one 3-point physical weight) and one part red (one 2-point physical weight (scaled to 1 point) and one 1-point physical weight (scaled to 0.75)). This color-coded display can aid users in evaluating food products (items) based not only on the cumulative score of their nutrition points, but also on their overall composition of higher versus lower quality ingredients. It is understood that according to various embodiments, the color-coded display need not present the “best” ingredients on the top (or in most prominent display location) of the bar graph. In some cases, the nutrition system can present the color-coded listing of product ingredients according to their physical weight in the product. For example, where a product is predominately composed of sugar, which could be a neutral ingredient (e.g., non-green, non-red), that color associated with sugar can be displayed on the top of the bar graph, with colors attributed to the lesser concentrated ingredients in descending order below.

In various embodiments, the nutrition system can be configured to prompt a user (e.g., a human user) to create a nutrition profile. The nutrition profile can include user dietary preferences based upon at least one of: a weight loss goal, a dietary restriction, a medical condition, etc. In some case, the nutrition system can be configured to provide the sorted normalized list of the dietary ingredients with at least one corresponding indicator based upon the dietary preferences of the user. For example, in the displayed summary chart for Food Item # 1 in FIG. 9, an ingredient (Ingredient K) is accompanied by an indicator (e.g., one or more asterisks) which notes that the ingredient contains a dietary preference concern (e.g., the ingredient contains gluten where the dietary preference is to exclude gluten, or the ingredient contains a high level of sugar where the dietary preference is related to diabetic concerns).

FIG. 9 shows an illustrative environment 101 including a nutrition system 126, for performing the functions described herein according to various embodiments of the invention. To this extent, the environment 101 includes a computer system 102 that can perform one or more processes described herein in order to allow for one or more user(s) 112 to interact with nutrition system 126 as described herein. In particular, the computer system 102 is shown as including the nutrition system 126, which makes computer system 102 operable to allow for one or more user(s) 112 to participate in nutrition functions by performing any/all of the processes described herein and implementing any/all of the embodiments described herein.

The computer system 102 is shown including a computing device 124, which can include a processing component 104 (e.g., one or more processors), a storage component 106 (e.g., a storage hierarchy), an input/output (I/O) component 108 (e.g., one or more I/O interfaces and/or devices), and a communications pathway 110. In general, the processing component 104 executes program code, such as the nutrition system 126, which is at least partially fixed in the storage component 106. While executing program code, the processing component 104 can process data, which can result in reading and/or writing transformed data from/to the storage component 106 and/or the I/O component 108 for further processing. The pathway 110 provides a communications link between each of the components in the computer system 102. The I/O component 108 can comprise one or more human I/O devices, which enable user(s) (e.g., a human and/or computerized user) 112 to interact with the computer system 102 and/or one or more communications devices to enable the system user(s) 112 to communicate with the computer system 102 using any type of communications link. To this extent, the nutrition system 126 can manage a set of interfaces (e.g., graphical user interface(s), application program interface, etc.) that enable human and/or system users(s) 112 to interact with the nutrition system 126. Further, the nutrition system 126 can manage (e.g., store, retrieve, create, manipulate, organize, present, etc.) data, such as user account data 60 and/or nutrition data 80 using any solution. In some embodiments, computing device 124 includes a database 134, which can store information such as nutrition data 80. Nutrition data 80 may be compiled prior to processes described herein, and can be used to compare with user account data 60 and data requests from user(s) 112 as described herein.

In any event, the computer system 102 can comprise one or more general purpose computing articles of manufacture (e.g., computing devices) capable of executing program code, such as the nutrition system 126, installed thereon. As used herein, it is understood that “program code” means any collection of instructions, in any language, code or notation, that cause a computing device having an information processing capability to perform a particular function either directly or after any combination of the following: (a) conversion to another language, code or notation; (b) reproduction in a different material form; and/or (c) decompression. To this extent, the nutrition system 126 can be embodied as any combination of system software and/or application software. It is further understood that the nutrition system 126 can be implemented in a cloud-based computing environment, where one or more processes are performed at distinct computing devices (e.g., a plurality of computing devices 124), where one or more of those distinct computing devices may contain only some of the components shown and described with respect to the computing device 124 of FIG. 4.

Further, the nutrition system 126 can be implemented using a set of modules 132. In this case, a module 132 can enable the computer system 102 to perform a set of tasks used by the nutrition system 126, and can be separately developed and/or implemented apart from other portions of the nutrition system 126. As used herein, the term “component” means any configuration of hardware, with or without software, which implements the functionality described in conjunction therewith using any solution, while the term “module” means program code that enables the computer system 102 to implement the functionality described in conjunction therewith using any solution. When fixed in a storage component 106 of a computer system 102 that includes a processing component 104, a module is a substantial portion of a component that implements the functionality. Regardless, it is understood that two or more components, modules, and/or systems may share some/all of their respective hardware and/or software. Further, it is understood that some of the functionality discussed herein may not be implemented or additional functionality may be included as part of the computer system 102.

When the computer system 102 comprises multiple computing devices, each computing device may have only a portion of nutrition system 126 fixed thereon (e.g., one or more modules 132). However, it is understood that the computer system 102 and nutrition system 126 are only representative of various possible equivalent computer systems that may perform a process described herein. To this extent, in other embodiments, the functionality provided by the computer system 102 and nutrition system 126 can be at least partially implemented by one or more computing devices that include any combination of general and/or specific purpose hardware with or without program code. In each embodiment, the hardware and program code, if included, can be created using standard engineering and programming techniques, respectively.

Regardless, when the computer system 102 includes multiple computing devices 124, the computing devices can communicate over any type of communications link. Further, while performing a process described herein, the computer system 102 can communicate with one or more other computer systems using any type of communications link. In either case, the communications link can comprise any combination of various types of wired and/or wireless links; comprise any combination of one or more types of networks; and/or utilize any combination of various types of transmission techniques and protocols.

The computer system 102 can obtain or provide data, such as user account data 60 and/or nutrition data 80 using any solution. The computer system 102 can generate user account data 60 and/or nutrition data 80, from one or more data stores, receive user account data 60 and/or nutrition data 80, from another system, send image user account data 60 and/or nutrition data 80 to another system, etc. As described herein, user account data 60 can include data about a user account, such as a points balance, dollar balance, bomb bucks balance, chips balance, history of performance using the nutrition system 126, profile information, etc.

User account data 60 can include, e.g., data about user(s) 112, which could be entered by a particular user 112, and/or generated based upon a general profile derived from other similar user data (e.g., data compiled about groups of users having similar height, weight, caloric intake, exercise frequency/intensity, etc.). User account data 60 can include profiles created by user 112, as well as dietary preferences/concerns (e.g., weight loss goals, allergies, medical conditions, etc.). Nutrition data 80 can include information about a variety of ingredients, sub-components of those ingredients, derivations/deviations from ingredients (as well as trace or nominal compositions within each of ingredient(s)), potential health benefits of particular ingredients or groups of ingredients, dietary concerns connected with particular ingredient(s), caloric content, as well as other dietary content from ingredient(s), etc.

While shown and described herein as a method and system for providing a nutrition system, it is understood that aspects of the invention further provide various alternative embodiments. For example, in one embodiment, the invention provides a computer program fixed in at least one computer-readable medium, which when executed, enables a computer system to provide a nutrition system. To this extent, the computer-readable medium includes program code, such as the nutrition system 126 (FIG. 9), which implements some or all of the processes and/or embodiments described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; paper; etc.

In another embodiment, the invention provides a method of providing a copy of program code, such as the nutrition system 126 (FIG. 9), which implements some or all of a process described herein. In this case, a computer system can process a copy of program code that implements some or all of a process described herein to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of program code that implements some or all of a process described herein, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of providing a nutrition system. In this case, a computer system, such as the computer system 102 (FIG. 9), can be obtained (e.g., created, maintained, made available, etc.) and one or more components for performing a process described herein can be obtained (e.g., created, purchased, used, modified, etc.) and deployed to the computer system. To this extent, the deployment can comprise one or more of: (1) installing program code on a computing device; (2) adding one or more computing and/or I/O devices to the computer system; (3) incorporating and/or modifying the computer system to enable it to perform a process described herein; etc.

In any case, the technical effect of the various embodiments of the invention, including, e.g., the nutrition system 126, is to allow users to participate in analyzing the nutritional attributes of food products as described herein.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A nutrition system comprising:
at least one computing device configured to perform the following:
normalizing a list of dietary ingredients from a product ingredient listing attributable to a food item;
sorting the normalized list of dietary ingredients, the sorting including assigning a weight to each of the normalized dietary ingredients according to a physical weight of the normalized dietary ingredient in the list of dietary ingredients; and
providing the sorted normalized list in a visually discernable format.

2. The nutrition system of claim 1, wherein the at least one computing device is further configured to sort the normalized dietary ingredients into three groups, wherein all of the normalized dietary ingredients are assigned a point value, the point value based upon membership in one of the three groups.

3. The nutrition system of claim 2, wherein each of the normalized dietary ingredients in a first group of the three groups is assigned a point value equal to three points, each of the normalized dietary ingredients in a second group of the three groups is assigned a point value equal to two points, and each of the normalized dietary ingredients in a third group of the three groups is assigned a point value equal to one point.

4. The nutrition system of claim 2, wherein the at least one computing device is further configured to add all of the point values for the normalized dietary ingredients to provide an overall dietary score for the food item.

5. The nutrition system of claim 2, wherein the at least one computing device is further configured to:
normalize a list of dietary ingredients from a second product ingredient listing attributable to a second, distinct food item;
sort the normalized list of dietary ingredients from the second product, the sorting including assigning a weight to each of the normalized dietary ingredients from the second product according to the physical weight of the normalized dietary ingredient in the list of dietary ingredients of the second product;
sort the normalized dietary ingredients from the second product into three groups, wherein all of the normalized dietary ingredients are assigned a point value, the point value based upon membership in one of the three groups; and
provide a visual comparison of the point value of the second product with the point value of the product.

6. The nutrition system of claim 5, wherein the at least one computing device is configured to normalize between the second product and the product for any difference in serving size or composition.

7. The nutrition system of claim 6, wherein the visual comparison includes a color-coded listing of the normalized dietary ingredients for the product and the second product.

8. The nutrition system of claim 7, wherein the color-coded listing includes:
displaying a red color where a normalized dietary ingredient has a point value of one;
displaying a green color where a normalized dietary ingredient has a point value of three; and
displaying a non-red, non-green color where a normalized dietary ingredient has a point value of two.

9. The nutrition system of claim 1, wherein the product ingredient listing includes a nutrition facts label attributable to the food item.

10. The nutrition system of claim 1, wherein the at least one computing device includes a database including the product ingredient listing, the database compiled prior to the normalizing of the list of dietary ingredients from the product ingredient listing.

11. The nutrition system of claim 1, wherein the at least one computing device is further configured to:
prompt a user to create a nutrition profile, the nutrition profile including user dietary preferences based upon at least one of: a weight loss goal, a dietary restriction or a medical condition; and
provide the sorted normalized list of the dietary ingredients with at least one corresponding indicator based upon the user dietary preferences.

12. A nutrition system comprising:
at least one computing device having:
a processor; and
a memory, the memory including a database having a set of product ingredient listings attributable to a set of food items,
the at least one computing device configured to provide nutrition information about a food item in the set of food items by performing processes including:
normalizing a list of dietary ingredients from a product ingredient listing attributable to the food item, the product ingredient listing stored in the set of product ingredient listings in the database;
sorting the normalized list of dietary ingredients, the sorting including assigning a weight to each of the normalized dietary ingredients according to a physical weight of the normalized dietary ingredient in the list of dietary ingredients;
sorting the normalized dietary ingredients into three groups, wherein all of the normalized dietary ingredients are assigned a point value, the point value based upon membership in one of the three groups; and
providing the sorted normalized dietary ingredients in a visually discernable format.

13. The nutrition system of claim 12, wherein each of the normalized dietary ingredients in a first group of the three groups is assigned a point value equal to three points, each of the normalized dietary ingredients in a second group of the three groups is assigned a point value equal to two points, and each of the normalized dietary ingredients in a third group of the three groups is assigned a point value equal to one point.

14. The nutrition system of claim 12, wherein the at least one computing device is further configured to add all of the point values for the normalized dietary ingredients to provide an overall dietary score for the food item.

15. The nutrition system of claim 12, wherein the at least one computing device is further configured to:
normalize a list of dietary ingredients from a second product ingredient listing attributable to a second, distinct food item, the second product ingredient listing stored in the set of product ingredient listings in the database;
sort the normalized list of dietary ingredients from the second product, the sorting including assigning a weight to each of the normalized dietary ingredients from the second product according to the physical weight of the normalized dietary ingredient in the list of dietary ingredients of the second product;
sort the normalized dietary ingredients from the second product into three groups, wherein all of the normalized dietary ingredients are assigned a point value, the point value based upon membership in one of the three groups; and
provide a visual comparison of the point value of the second product with the point value of the product.

16. The nutrition system of claim 15, wherein the at least one computing device is configured to normalize between the second product and the product for any difference in serving size or composition.

17. The nutrition system of claim 16, wherein the visual comparison includes a color-coded listing of the normalized dietary ingredients for the product and the second product.

18. The nutrition system of claim 17, wherein the color-coded listing includes:
displaying a red color where a normalized dietary ingredient has a point value of one;
displaying a green color where a normalized dietary ingredient has a point value of three; and
displaying a non-red, non-green color where a normalized dietary ingredient has a point value of two.

19. The nutrition system of claim 12, wherein the at least one computing device is further configured to:
prompt a user to create a nutrition profile, the nutrition profile including user dietary preferences based upon at least one of: a weight loss goal, a dietary restriction or a medical condition; and
provide the sorted normalized list of the dietary ingredients with at least one corresponding indicator based upon the user dietary preferences.

20. A computer program stored on a computer-readable storage medium, which when executed by at least one computing device, causes the at least one computing device to perform a process of providing nutrition information about a food item, the process including:
normalizing a list of dietary ingredients from a product ingredient listing attributable to the food item;
sorting the normalized list of dietary ingredients, the sorting including assigning a weight to each of the normalized dietary ingredients according to a physical weight of the normalized dietary ingredient in the list of dietary ingredients; and
providing the sorted normalized list in a visually discernable format.
